(19) United States
(12) Patent Application Publication
(10) Pub. No.: US 2017/0276081 A1
(43) Pub. Date: Sep. 28, 2017

(54) METHOD OF CONTROLLING CYLINDER DEACTIVATION AND CDA SYSTEM APPLIED BY THE METHOD

(71) Applicant: Hyundai Motor Company, Seoul (KR)

(72) Inventor: Gee Wook SHIN, Hwaseong-si (KR)

(73) Assignee: Hyundai Motor Company, Seoul (KR)

(21) Appl. No.: 15/373,862

(22) Filed: Dec. 9, 2016

(30) Foreign Application Priority Data
Mar. 28, 2016 (KR) 10-2016-0037193

(51) Int. Cl. F02D 41/00; F02D 41/30; F02D 17/02

(52) U.S. Cl. CPC F02D 41/0087; F02D 41/0002; F02D 17/02; F02D 41/3064; F02D 2041/0012; F02D 2041/002; F02D 2200/501; F02D 2200/0406; F02D 2200/1002; F02D 2200/602; F02D 2250/21

(57) ABSTRACT

A method of controlling CDA conversion may include determining whether CDA device is in CDA mode driving area according to obtained vehicle operation status signal; preparing, when CDA device is in CDA mode driving area, for operating in the CDA driving mode; performing conversion to CDA mode on each cylinder of the CDA device; and controlling, when CDA device is not in DA mode driving area, vehicle driving according to normal area operation map of the CDA device, wherein at performing of conversion to CDA mode on each cylinder, when converting mode of the CDA device from on-operation mode to an operation mode, after combustion is performed in selected cylinder, first exhaust valve maintains an operation state, and remaining exhaust valves and intake valves are converted to non-operation state to perform an exhaust anti-trap control.

### CROSS-REFERENCE TO RELATED APPLICATION

The present application claims priority to Korean Patent Application No. 10-2016-0037193 filed on Mar. 28, 2016, the entire contents of which is incorporated herein for all purposes by this reference.

### BACKGROUND OF THE INVENTION

Field of the Invention

The present invention relates to a method of controlling cylinder deactivation (CDA) conversion and a CDA system to which the method is applied. More particularly, the present invention relates to a method of controlling CDA conversion and a CDA system to which the method is applied that can reduce a torque change by controlling activation order of an exhaust valve and an intake valve upon converting to a CDA driving mode.

Description of Related Art

Nowadays, due to sharp rise of a price of oil that is used as a power source of a vehicle, in engine development, fuel consumption enhancement technology has been largely in the spotlight.

In a low load condition of a predetermined vehicle speed or more or in an idle condition of low request power, when generating power by operating an entire combustion chamber, surplus power occurs and thus in order to reduce such surplus power, a CDA device is applied to an engine.

An engine having the CDA device deactivates some or the entire of a combustion chamber according to an engine operation state, thereby improving fuel consumption.

In the engine having the CDA device, in a stopped (deactivated) combustion chamber, because fuel ejection is not performed, a fuel consumption amount reduces, and in a stopped cylinder, because a power loss does not occur due to a friction, a considerable level of fuel consumption gain may be obtained.

FIGS. 3 to 5 are diagrams illustrating a structure of a CDA device that is applied to a conventional engine.

Operation of the CDA device that is mounted in a conventional engine will be described with reference to FIGS. 3 to 5.

The CDA device is formed with a cylinder-shaped inner tappet 3 having an opened low surface that contacts an upper end portion of a stem portion 1a of an intake valve/exhaust valve and a hollow cylinder-shaped outer tappet 5 that is installed at an external circumference and that is formed coaxially with the inner tappet 3, and a locking pin 7 that selectively engages and releases the inner tappet 3 and the outer tappet 5 by a supplied hydraulic pressure is installed therebetween.

Further, in a camshaft 9, because a short stroke cam 11 and a long stroke cam 13 are each installed, the short stroke cam 11 is disposed to contact the inner tappet 3 and the long stroke cam 13 is disposed to contact the outer tappet 5.

Accordingly, as a hydraulic pressure is supplied due to turn-on of operation of the CDA device, when the locking pin 7 releases engagement of the inner tappet 3 and the outer tappet 5, the lift of an intake valve/exhaust valve by driving of the camshaft 9 depends on a protrusion distance of a cam nose of the short stroke cam 11.

Therefore, when operation of the intake valve and the exhaust valve is not performed according to driving of the camshaft 9, air is not supplied to the combustion chamber and is not discharged from the combustion chamber and thus at a corresponding combustion chamber, combustion does not occur.

However, as a supplied hydraulic pressure is discharged due to turn-off of operation of the CDA device, when the locking pin 7 engages the inner tappet 3 and the outer tappet 5, the lift of the intake valve/the exhaust valve according to driving of the camshaft 9 depends on a protrusion distance of a cam nose of the lone stroke cam 13.

Therefore, operation of the intake valve and the exhaust valve is normally performed according to driving of the camshaft 9 and thus air is supplied to the combustion chamber and is discharged from the combustion chamber, thereby providing normal combustion.

In such conventional art; when the CDA device operates with conversion of a CDA driving mode, an exhaust gas of a cylinder that is burned in the combustion chamber is maintained instead of being discharged to the outside and thus a compression pressure may largely occur (exhaust trap strategy). Further, an exhaust gas of the burned cylinder may be discharged and new air may be maintained at the burned cylinder (intake trap strategy).

In the exhaust trap strategy and the intake trap strategy, when the CDA device operates with conversion of a CDA driving mode, in a state in which the cylinder is deactivated, a pressure largely occurs or is maintained within a cylinder and thus a cylinder torque change increases. That is, a problem occurs that a friction increases and that a torque change increases by a remaining gas within the deactivated cylinder.

Further, when not operating an operated CDA device in the exhaust trap strategy and the intake trap strategy, in the exhaust trap strategy, by opening an exhaust valve, a process of discharging a remaining gas and absorbing new air should be performed, and in the intake trap strategy, an unnecessary process of discharging remaining new air and absorbing new air should be performed. Particularly, in the intake trap strategy, because a lambda control is not appropriately performed by remaining new air, a problem may occur that fuel is excessively injected.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of controlling CDA conversion and a CDA system to which the method is applied having advantages of being capable of reducing a torque change by removing a remaining gas within a deactivated cylinder by controlling operation order of an exhaust valve and an intake valve upon converting to a CDA driving mode.

Various aspects of the present invention are directed to providing a method of controlling cylinder deactivation (CDA) conversion including: obtaining an operation status signal of a vehicle; determining whether an CDA device is in a CDA mode driving area according to the obtained operation status signal of the vehicle; preparing, when an CDA device is in a CDA mode driving area, for operating in the CDA driving mode; performing conversion to a CDA mode on each cylinder of the CDA device; and controlling, when an CDA device is not in a CDA mode driving area, vehicle driving according to a normal area operation map of the CDA device, wherein at the performing of conversion to a CDA mode on each cylinder, when converting a mode of the CDA device from a non-operation mode to an operation mode, after combustion is performed in a selected cylinder, a first exhaust valve maintains an operation state, and the remaining exhaust valves and intake valves are converted to a non-operation state to perform an exhaust anti-trap control that discharges the entire exhaust gas and that does not receive new air in a state in which the first exhaust valve is opened.

At the performing of conversion to a CDA mode on each cylinder, when converting a mode of the CDA device from an operation mode to a non-operation mode, in a selected cylinder, the first exhaust valve may maintain a non-operation state via a deactivated state, and the remaining intake valves and exhaust valves may convert to an operation state to perform an intake anti-trap control that first absorbs new air through the intake valve and that performs combustion in a state in which the first exhaust valve is closed.

The vehicle operation status signal may include an engine speed signal, a vehicle speed signal, and an oil temperature signal, and the method may further include determining whether the CDA device is in a CDA mode driving area by substituting the vehicle operation status signal to a predetermined map.

The vehicle operation status signal may further include: a manifold pressure signal; an output torque signal of an engine; and a location signal of an accelerator pedal, and the method may further include determining whether the CDA device is in a CDA mode driving area by substituting the vehicle operation status signal to a predetermined map.

The preparing of for operating in the CDA driving mode may include: limiting purge that discharges a gas within a cylinder; and fixing a phase angle and a target torque of a Continuous Variable Valve Timing (CVVT) device.

The performing of conversion to a CDA mode on each cylinder of the CDA device may include: a first step of CDA mode conversion on each cylinder; and a second step of CDA mode conversion on each cylinder, wherein the first step of CDA mode conversion on each cylinder may include: controlling operation of a CVVT device; retarding ignition timing; and increasing an air amount by opening a throttle valve in consideration of the number of cylinders to deactivate among cylinders.

The performing of conversion to a CDA mode on each cylinder of the CDA device may further include: determining whether the output torque is maintained to a predetermined target torque; and performing, when the output torque is not maintained to a predetermined target torque, the first step of CDA mode conversion on each cylinder.

The second step of CDA mode conversion on each cylinder may be performed, when the output torque is maintained to a predetermined target torque, and the second step of CDA mode conversion on each cylinder may include: detecting a currently burning cylinder; selecting a cylinder to convert to an initial mode in the CDA device; performing an exhaust anti-trap control strategy and an intake anti-trap control strategy; applying power to an OCV of the initially selected cylinder; and blocking fuel injection and ignition of the initially selected cylinder.

The second step of CDA mode conversion on each cylinder of the CDA device may further include: applying power to an OCV of a cylinder to convert a mode among the remaining cylinders in firing order; and blocking fuel injection and ignition of the cylinder to convert.

The performing of conversion to a CDA mode on each cylinder of the CDA device may further include: detecting an air amount of a cylinder having a converted mode in the CDA device; determining a value of a previously input map; and completing CDA conversion based on the detected air amount and map.

According to a method of controlling CDA conversion and a CDA system to which the method is applied according to an exemplary embodiment of the present invention, upon converting to a CDA driving mode, an excessive torque change by a remaining exhaust gas can be prevented. Further, by discharging an exhaust gas remaining in a previous cycle and by stably controlling an air/fuel ratio, an appropriate lambda control can be performed. Further, as a torque change due to conversion to a driving mode is minimized, a driver can drive more comfortably a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a configuration of a CDA system according to an exemplary embodiment of the present invention.

FIG. 2 is flowchart illustrating a method of controlling CDA conversion according to an exemplary embodiment of the present invention.

FIG. 3 is a first status graph to which a method of controlling CDA conversion is applied according to an exemplary embodiment of the present invention.

FIG. 4 is a second status graph to which a method of controlling CDA conversion is applied according to an exemplary embodiment of the present invention.

FIG. 5 is a diagram illustrating a structure of a CDA device that is applied to a conventional engine.

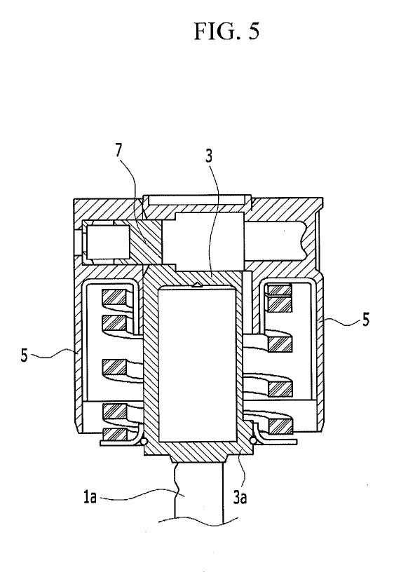

FIG. 6 is a diagram illustrating operation-off of a CDA device that is applied to a conventional engine.

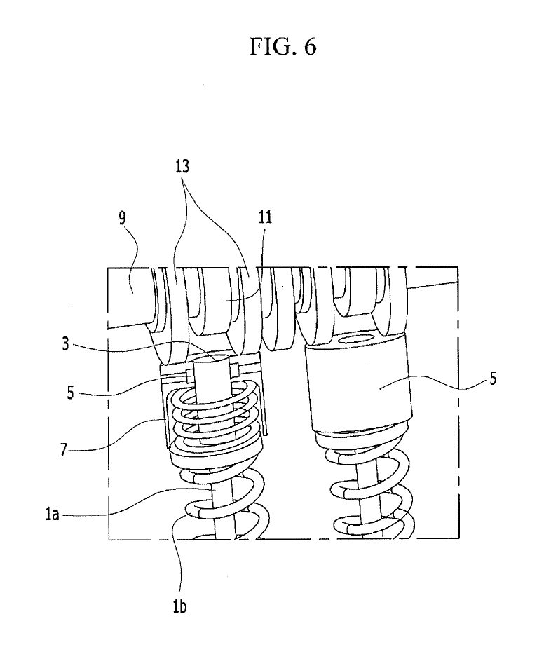

FIG. 7 is a diagram illustrating operation-on of a CDA device that is applied to a conventional engine.

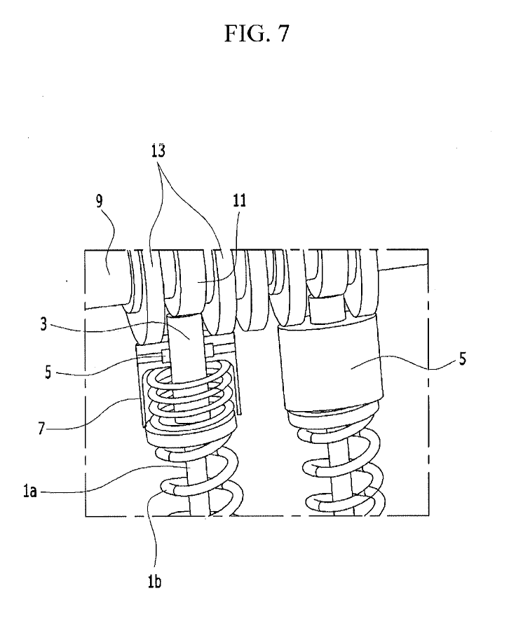

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain example embodiments of the present invention have been shown and described, simply by way of illustration.

As those skilled in the art would realize, the described embodiments may be modified in various different ways, all without departing from the spirit or scope of the present invention

In addition, in an entire specification, unless explicitly described to the contrary, the word “comprise” and variations such as “comprises” or “comprising”, will be understood to imply the inclusion of stated elements but not the exclusion of any other elements.

An example embodiment of the present invention will hereinafter be described in detail with reference to the accompanying drawings.

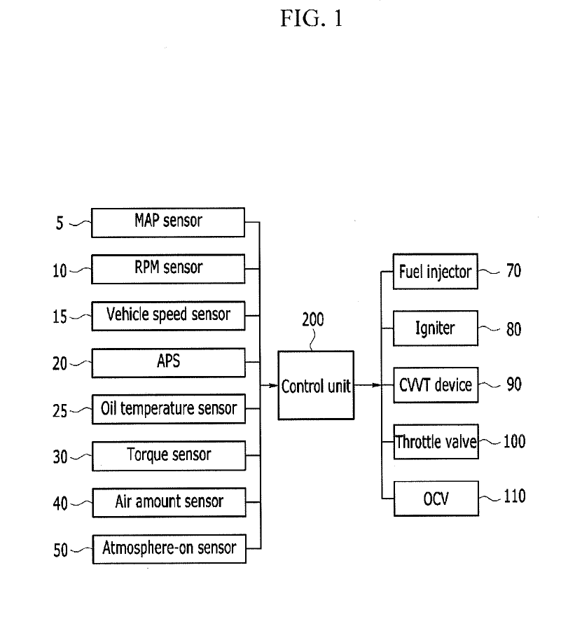

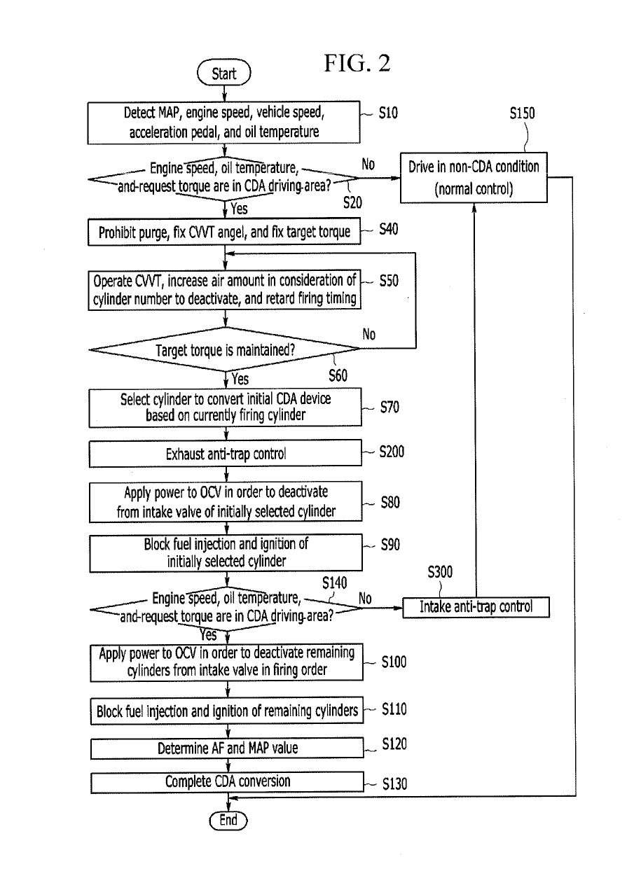

FIG. 1 is a block diagram illustrating a configuration of a CDA system according to an exemplary embodiment of the present invention, and FIG. 2 is flowchart illustrating a method of controlling CDA conversion according to an exemplary embodiment of the present invention.

Referring to FIG. 1, a CDA system according to an exemplary embodiment of the present invention includes a Manifold Absolute Pressure sensor (MAP sensor) 5 that measures and outputs a pressure of a manifold, an engine speed sensor (RPM sensor) 10 that measures a rotation speed of an engine and that outputs a corresponding signal, a vehicle speed sensor 15 that measures a speed of a vehicle and that outputs a corresponding signal, an Accelerator Position Sensor (APS) 20 that detects a level in which a driver presses an accelerator pedal and that outputs a request torque signal, an oil temperature sensor 25 that measures an oil temperature of an engine and that outputs a corresponding signal, a torque sensor 30 that measures an output torque of the engine and that outputs a corresponding signal, and an air amount sensor 40 that measures an air amount that is injected into the engine and that outputs a corresponding signal.

Further, the CDA system may further include an atmosphere-on sensor 50 that measures an atmosphere temperature and that outputs a corresponding signal.

A control device 200 obtains a signal of the each sensor to determine an operation state of the vehicle and controls operation of a fuel injector 70 that ejects fuel according to the determined operation state, an igniter 80 that explodes fuel within a cylinder, a Continuous Variable Valve Timing (CVVT) device 90 that controls timing of a valve lift, a throttle valve 100 that controls an air amount that is injected into the engine, and an oil control valve (OCV) 110 that controls operation of the CDA device that implements deactivation of the cylinder.

Referring to FIG. 2, a method of controlling CDA conversion according to the present exemplary embodiment includes step S10 of obtaining, by the control device 200, an operation status signal of a vehicle and step S20 of determining, by the control device 200, whether a CDA device is in a CDA mode driving area according to the obtained operation status signal of the vehicle.

When a CDA device is in a CDA mode driving area, the method may include step S40 of preparing for operating in the CDA driving mode, a first step S50 of CDA mode conversion on each cylinder of the CDA device, and determining whether a target torque may be maintained by mode conversion of the CDA device at step S60, and when a CDA device is not in a CDA mode driving area, the method may include step S150 of controlling vehicle driving according to a normal area operation map of the CDA device.

The vehicle operation status signal includes an engine speed signal, a vehicle speed signal, and an oil temperature signal. The control device 200 determines whether the CDA device is in a CDA mode driving area by substituting the vehicle operation status signal to a predetermined map at the step S20, and controls vehicle driving according to a normal area operation map of the CDA device at the step S150 when the CDA device is not in a CDA mode driving area based on the engine speed signal, the vehicle speed signal, and the oil temperature signal.

The vehicle operation status signal further includes a manifold pressure signal, an engine output torque signal, and an accelerator pedal position signal that are detected by the MAP sensor 5, the torque sensor 30, and the APS 20. The control device 200 may determine whether the CDA device is in a CDA mode driving area and determine a level of a request torque amount by substituting the vehicle operation status signals to a predetermined map.

The step S40 of preparing for operating in the CDA driving mode may include step of limiting purge that discharges a gas within a cylinder and step of fixing a phase angle and target torque of a CVVT device. When the step S40 of preparing for operating in the CDA driving mode is complete, the first step S50 of CDA mode conversion on each cylinder of the CDA device is performed.

The first step S50 of CDA mode conversion on each cylinder of the CDA device may include step of controlling operation of the CVVT device, step of retarding ignition timing, and step of increasing an air amount in consideration of the number of cylinders to deactivate among the cylinders.

For this reason, the control device 200 may control operation of the CVVT device 90, the throttle valve 100, and the igniter 80, operate the CVVT device 90, increase an air amount by opening the throttle valve 100, and retard ignition timing.

In this way, the control device 200 previously controls operation of the CVVT device 90, and this is to prevent delay of a CDA conversion procedure because a reaction of the CVVT device 90 is relatively slow. Further, the control device 200 previously acquires an air amount by controlling operation of the throttle valve 100 and retards ignition timing by controlling operation of the igniter 80, minimizing a change of a request torque amount before converting to a CDA mode.

The control device 200 performs the first step S50 of CDA mode conversion on each cylinder and determines whether a target torque is maintained at step S60. When the target torque is not maintained, the control device 200 again performs a CDA mode conversion step on each cylinder of the CVVT device 90 at the step S50. The target torque may be a value that is previously set or mapped.

When the target torque is maintained, the control device 200 performs a second step of CDA mode conversion on a cylinder. The second step of CDA mode conversion on each cylinder may include step S70 of selecting a cylinder to convert to an initial mode in CDA devices based on a currently burning cylinder, step S80 of applying power to the OCV 110 to deactivate the initially selected cylinder, and step S90 of blocking fuel injection and ignition of the initially selected cylinder.

That is, the control device 200 may select a cylinder to convert to an initial mode, perform mode conversion of the CDA device by first applying power to the OCV 110 from the selected cylinder, and deactivate a cylinder by blocking fuel injection and ignition of the initially selected cylinder.

According to an exemplary embodiment of the present invention, when the control device 200 selects a cylinder to convert to an initial mode among burning cylinders and converts to operate a CDA device of the cylinder, combustion is performed in the selected cylinder and then the control device 200 controls to open an exhaust valve to discharge the entire exhaust gas and to close an intake valve not to receive new air. Hereinafter, such a control is referred to as an exhaust anti-trap control.

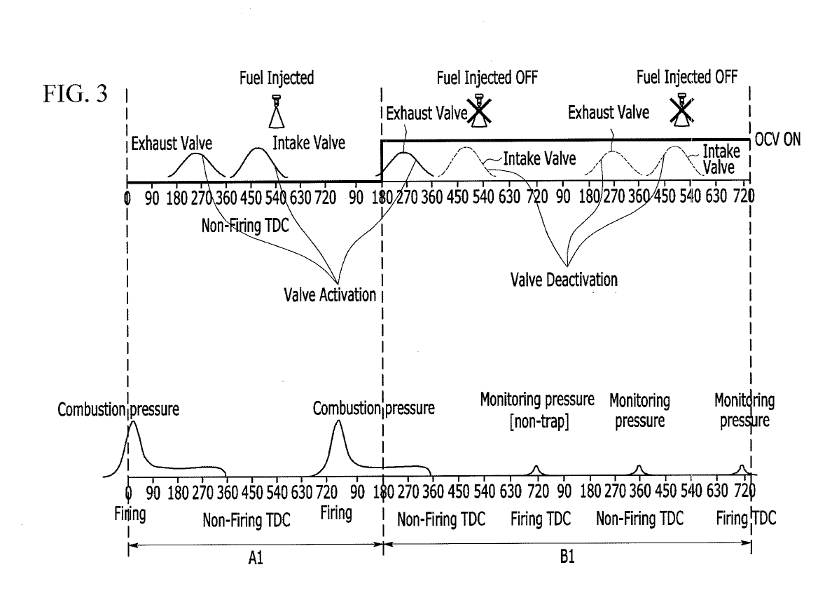

That is, as shown in FIG. 3, according to an exhaust anti-trap control, after a first combustion step A1 in which the injector 70 injects fuel, a first cylinder deactivation step B1 is started. At the first combustion step A1, the entire exhaust valve and intake valve are activated to be opened, and at the first cylinder deactivation step B1, only an exhaust valve is first activated to be opened and the remaining exhaust valves and intake valves are deactivated to be closed.

As described above, at the first cylinder deactivation step B1, when a first exhaust valve is opened and a next intake valve is closed, a state is available in which the entire remaining exhaust gas within the cylinder is discharged through the opened exhaust valve and in which new air is not received. At the first cylinder deactivation step B1, power is applied to the OCV 110 and thus the CDA device operates, and from a next cycle in which the first exhaust valve is opened, the entire intake valve and exhaust valve are deactivated to be closed. When the control is performed in this way, as shown at the lower end of FIG. 3, at the first cylinder deactivation step B1, a pressure of a cylinder to which an exhaust anti-trap control is applied is remarkably reduced and thus a torque change may be reduced.

The second step of CDA mode conversion on each cylinder of the CDA device includes step S100 of applying power to an OCV of a cylinder to convert a mode among the remaining cylinders in firing order and step S110 of blocking fuel injection and ignition of a cylinder to convert among the remaining cylinders.

Thereafter, the control device 200 determines a value of an air amount of a cylinder having a converted mode in the CDA device detected through the air amount sensor 40 and determines the previously input MAP at step S120 and completes CDA conversion at step S130.

For example, the control device 200 may compare an input signal from the air amount sensor 40 with the previously input MAP, determine whether an air amount that is currently supplied to the engine is an air amount according to CDA mode conversion, and determine whether conversion of the CDA mode is complete. Further, the control device 200 may control operation of the injector 70, the igniter 80, and the CVVT device 90 according to predetermined CDA mode injection timing and CVVT timing and an ignition timing map at the step S120.

Meanwhile, the method of CDA conversion further includes performing conversion from a CDA on-mode to CDA off-mode, the performing conversion from a CDA on-mode to CDA off-mode may be performed between the step S90 and the step S100.

The performing conversion from the CDA on-mode to CDA off-mode includes determining whether the CDA device is in the CDA mode driving area at step S140. When the CDA device is not in the CDA mode driving area based on the engine speed signal, the vehicle speed signal, and the oil temperature signal, then the control device 200 performs an intake anti-trap control at step S300.

In other words, the control device 200 selects a cylinder to convert mode among deactivating cylinders, and when the cylinder selected may be converted to CDA off-mode, an exhaust valve of the cylinder selected is in a state that is not operated, and an intake valve is opened to absorb new air.

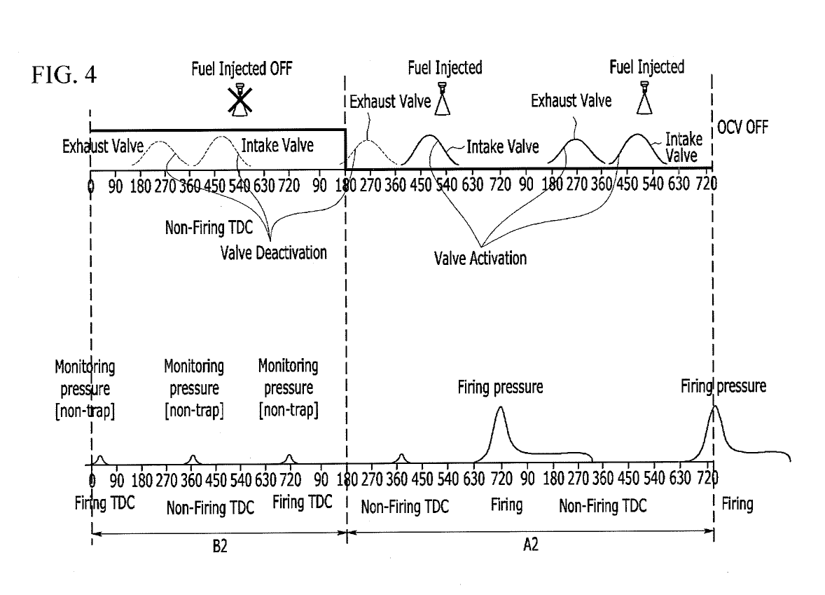

As shown in FIG. 4, according to an intake anti-trap control, a second combustion step A2 is performed that injects fuel via a second cylinder deactivation step B2 in which the injector 70 does not inject fuel. At the second cylinder deactivation step B2, an exhaust valve and an intake valve are entirely deactivated to be closed, and at the second combustion step A2, only the intake valve is first deactivated to be closed, and the remaining intake valves and exhaust valves are entirely activated to be opened. At the second cylinder deactivation step B2, a state is maintained in which power is applied to the OCY 110, and at the second combustion step A2, application of power to the OCV 110 is released and thus the CDA device does not operate.

Therefore, at the second combustion step A2, only a first exhaust valve is deactivated to be closed, and the entire following intake valves and exhaust valves are opened while being activated. In a cylinder to which such an intake anti-trap control is applied, an unnecessary process that may discharge the remaining new air is removed and new air is not remained within the cylinder and thus there is a merit that a constant lambda control is available. Further, a torque change remarkably reduces.

After the intake anti-trap control of the cylinder, the CDA device is operated according to the normal area operation map at the step S150.

In this way, in a method of controlling CDA conversion according to an exemplary embodiment of the present invention, upon converting to a CDA driving mode, by previously acquiring an air amount, a CDA mode is sequentially converted in firing order, and upon converting to a CDA driving mode, by removing the remaining gas within a deactivated cylinder by controlling operation order of an exhaust valve and an intake valve, upon converting to CDA, a torque change can be effectively reduced.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling cylinder deactivation (CDA) conversion, the method comprising:
obtaining an operation status signal of a vehicle;
determining whether an CDA device is in a CDA mode driving area according to the obtained operation status signal of the vehicle;
preparing, when an CDA device is in a CDA mode driving area, for operating in the CDA driving mode;
performing conversion to a CDA mode on each cylinder of the CDA device; and
controlling, when an CDA device is not in a CDA mode driving area, vehicle driving according to a normal area operation map of the CDA device,
wherein the performing of conversion to the CDA mode on each cylinder includes
selecting a cylinder to convert a mode of the CDA device from an off-mode to an on-mode;
operating an exhaust valve of the cylinder selected to be opened initially after combustion is performed in the cylinder selected; and
maintaining following exhaust valves and intake valves after the exhaust valve of the cylinder selected to a non-operation state to be closed to perform an exhaust anti-trap control that discharges an entire exhaust gas and that does not receive new air in a state in which the exhaust valve is configured to be opened initially.

2. The method of claim 1, further including:
performing conversion from a CDA on-mode to CDA off-mode,
wherein when converting a mode of the CDA device from the on-mode to the off-mode, a cylinder to convert is selected, and after an exhaust valve converts a non-operation state to be closed via a deactivated state at first, and the following intake valves and exhaust valves after the first exhaust valve maintain to an operation state to be opened to perform an intake anti-trap control that first absorbs new air through the intake valve in a state in which the exhaust valve is configured to be closed state and after performs combustion.

3. The method of claim 2, wherein the vehicle operation status signal includes an engine speed signal, a vehicle speed signal, and an oil temperature signal, and further includes a manifold pressure signal, an output torque signal of an engine, and a location signal of an accelerator pedal, and
wherein the method further includes determining whether the CDA device is in a CDA mode driving area by substituting the vehicle operation status signal to a predetermined map.

4. The method of claim 3, wherein the preparing of for operating in the CDA driving mode includes:
limiting purge that discharges a gas within a cylinder; and
fixing a phase angle and a target torque of a Continuous Variable Valve Timing (CVVT) device.

5. The method of claim 4, wherein the performing of conversion to a CDA mode on each cylinder of the CDA device includes:
a first step of CDA mode conversion on each cylinder; and
a second step of CDA mode conversion on each cylinder,
wherein the first step of CDA mode conversion on each cylinder includes:
controlling operation of the CVVT device;
retarding ignition timing; and
increasing an air amount by opening a throttle valve in consideration of a number of cylinders to deactivate among cylinders.

6. The method of claim 5, wherein the performing of conversion to the CDA mode on each cylinder of the CDA device further includes:
determining whether the output torque is maintained to a predetermined target torque; and
performing, when the output torque is not maintained to a predetermined target torque, the first step of CDA mode conversion on each cylinder.

7. The method of claim 6, wherein the second step of CDA mode conversion on each cylinder is performed, when the output torque is maintained to a predetermined target torque, and
wherein the second step of CDA mode conversion on each cylinder includes:
detecting a currently burning cylinder;
selecting a cylinder to convert to an initial mode in the CDA device;
performing the exhaust anti-trap control;
applying power to an oil control valve (OCV) of the initially selected cylinder to deactivate; and
blocking fuel injection and ignition of the initially selected cylinder;
performing conversion from a CDA on-mode to CDA off-mode,
wherein when converting a mode of the CDA device from the on-mode to the off-mode, a cylinder to convert is selected, and after an exhaust valve converts a non-operation state to be closed via a deactivated state at first, and the following intake valves and exhaust valves after the first exhaust valve maintain to an operation state to be opened to perform an intake anti-trap control.

8. The method of claim 7, wherein the second step of CDA mode conversion on each cylinder of the CDA device further includes:
applying power to an oil control valve (OCV) of a cylinder to convert a mode among the remaining cylinders in firing order; and
blocking fuel injection and ignition of the cylinder to convert.

9. The method of claim 1, wherein the performing of conversion to the CDA mode on each cylinder of the CDA device further includes:
detecting an air amount of a cylinder having a converted mode in the CDA device;
determining a value of a previously input map; and
completing CDA conversion based on the detected air amount and map.

10. A cylinder deactivation (CDA) system comprising a control device that obtains a corresponding signal of a manifold absolute pressure sensor, an engine speed sensor, an oil temperature sensor, a vehicle speed sensor, a torque sensor, and an air amount sensor to control operation of a fuel injector, an igniter, a Continuous Variable Valve Timing (CVVT) device, a throttle valve, and an oil control valve (OCV) for the CDA device, wherein a series of programs that execute an instruction of the claim 1 are stored at the control device.
